(19) United States
(12) Patent Application Publication
(10) Pub. No.: US 2010/0074274 A1
(43) Pub. Date: Mar. 25, 2010

(54) SYSTEM FOR RESERVING A PASS BAND FOR DIFFERENT CLASSES OF TRAFFIC

(76) Inventor: Bertrand Huguies, Nantes (FR)

Correspondence Address: Robert D. Shedd, Patent Operations;THOMSON Licensing LLC, P.O. Box 5312, Princeton, NJ, 08543-5312, US

(21) Appl. No.: 12/448,125

(22) PCT Filed: Dec. 4, 2007
(86) PCT No.: PCT/FR2007/052436

§ 371 Date: Jun. 8, 2009

(30) Foreign Application Priority Data
Dec. 6, 2006 (FR) 0655333

(51) Int. Cl. H04J 3/22

(52) U.S. Cl. 370/468

(57) ABSTRACT

The present invention relates to a bandwidth reservation system in a communication network comprising a centralized bandwidth manager that implements a bandwidth reservation protocol and that is linked to at least one host, wherein an external entity supplies the centralized bandwidth manager with an updated view of the network logical topology,

and wherein the centralized bandwidth manager comprises means for, on reception of a bandwidth reservation request between a source and a destination for certain class of traffic, calculating the current network path between the source and the destination by using an algorithm, said path borrowing at least one link of the network, and means for verifying on each link of the path that there is sufficient bandwidth available for the requested class of traffic in the requested reservation. The present invention also relates to a communication device, in a communication network, implementing a bandwidth reservation protocol and linked to at least one host.

### SCOPE OF THE INVENTION

The present invention relates to the domain of networks.

The present invention relates more particularly to a bandwidth reservation system, reliable and capable of adapting, for different classes of traffic, to loop-free networks with dynamic and constraint-free topology. The present invention applies to loop-free networks, that is at a given moment, there is a unique path between two points of the network and that this unique path is only modified by a topology change of the network. A “constraint free” topology means that the network equipment, notably the hosts and the network core equipment, are connected in an irrelevant way. A “dynamic” network topology means that the network topology changes over time.

An example of a loop-free network is Ethernet, which can be used with the STP protocol (Spanning Tree Protocol) but this is not the only example. In particular, wireless networks can be loop-free.

### PRIOR ART

Bandwidth reservation consists in allocating or not allocating a data transfer by giving each stream a bandwidth limitation. This reservation comprises two steps:
A first step consisting in controlling and verifying that the reservation can be granted, and
A second step consisting in applying this reservation to the network in such a manner that the streams are guaranteed according to the granted reservation.

It is known in the prior art several systems and methods enabling the QoS (quality of service) to be supplied in a network environment. The three main architectures are:
DiffSery (Differentiated Services),
IntSery (Integrated Services), and
MPLS (MultiProtocol Label Switching).

The DiffSery model uses an implementation of the IPv4 TOS (Type of Service) header field and of the IPv6 traffic class field. The purpose of the differentiated services is to provide a scalable service discrimination without needing to maintain a status per stream or carrying out per hop signalling. This solution provides means for discriminating different types of stream but this discrimination is not determinist to the extent that the different classes of traffic are simply defined in a textual manner such that each item of network equipment can implement its own discrimination policy, according to its own interpretation of the definition of class of traffic. Hence, with this solution, it is impossible to guarantee a strict discrimination of the streams. Moreover, the DiffSery solution does not enable the bandwidth to be reserved.

The IntSery integrated service model consists in two types of services to support real time services: a predictive service and a guaranteed service. An important hypothesis is that the network resources can be controlled in an explicit manner. This means that the reservation of resources and the admission control are basic blocks of the router model. Admission control implements the decision algorithm that a router or a host uses to determine whether a new stream can be granted the quality of service requested without affecting prior guarantees. The Resource Reservation Protocol (RSVP) is responsible for the creation of the specific stream information in the end hosts and in the routers throughout the path from the source to the destination. The IntSery solution enables a determinist bandwidth reservation to be provided that comprises quality of service (QoS) functionalities. The disadvantage, if the objective of the framework of the present invention is followed, is that IntSery operates only with routers, that is at the level of the layer 3 of the OSI stack where the constraints of a loop-free network are not respected.

MPLS is a general technique for the rapid transportation of IP packets (Internet Protocol) or other units of data corresponding to a protocol, by using labels assigned to packets. It enables load balancing to be carried out and data to be routed around points of congestion and thus the effectiveness of the network to be improved and high levels of QoS (quality of service) to be provided. Among the disadvantages of MPLS, it is found the fact that this technique does not enable the QoS and the multicast to be handled at the same time. By reason of the fact that a diversity of services with different QoS constraints can be supported in the current networks, DiffSery traffic engineering is used as an extension of MPLS. Separate tunnels for each service class are implemented. Each tunnel corresponds to a traffic aggregate requiring the same processing in terms of QoS. The tunnels are set up between source and destination nodes in the communication network and an appropriate bandwidth is reserved for each of them. MPLS can be implemented on switches that use the network layer (layer 3) in the TCP/IP stack, but the QoS functionalities have not yet been implemented. Hence, this solution does not respond to the problem that the present invention proposes to solve.

In the specific network environment of the present invention, the DiffSery model is not adapted to the requirements, owing to the fact that the bandwidth is not guaranteed. The difficulty is as follows: as soon as the number of users is too high, each stream will be degraded, even those that have real time constraints. The IntSery model meets the service quality constraints, but the RSVP protocol is only implemented on routers, which are not part of a loop-free network.

Other work has concerned the implementation of a protocol to enable applications to reserve bandwidth. One part of this work, NetRAP, is a protocol based on a system of tokens and used to give applications access to the network with a bandwidth guarantee. With this protocol, each application requiring a guaranteed bandwidth begins a session. The token carries out a rotation among the sessions: only the one that has the token has the permission to transmit data. The one that has the token keeps the token for the THT (Token Holding Time) at the most, that is a portion of the predetermined time called TRT (Token Rotation Time), and passes the token on to another session. The TRT is the time of turn of the token for a session. After the last session has had the token, other applications can access the network to send non-guaranteed data until the TRT is reached, to enable the first session to have the token, and so on. An application that has started a session has the guarantee that collisions cannot arise because one session only and therefore a single network node can have the token at a given moment. This solution is very restrictive as it does not enable many streams to be transmitted simultaneously and does not manage any functionality related to quality of service.

In the Ethernet networks, where the switches are the only network equipment, several solutions have attempted to resolve the problem of bandwidth reservation.

The prior art knows, through the American patent U.S. Pat. No. 6,941,380 (Nortel), a method enabling bandwidth to be allocated in an Ethernet network having a topology with constraints. The invention, purpose of this American patent, is based on a centralised manager that receives bandwidth requests, checks whether the bandwidth is available and responds to the equipment that made the request. The limiting functionalities of the system are that it is based on a network topology with constraint and that it is not aware of classes of traffic This American patent describes how to reserve bandwidth in two cases of network architectures, illustrated FIGS. 1 and 2 in this American patent. The system does not have the capacity to reserve bandwidth outside of the framework of these two network examples. The second limitation is that, although the system is capable of reserving bandwidth, it is not able to perform discriminations between different types of traffic that comprise different quality of service constraints within these reservations.

Other patents and patent applications, such as the documents WO 2006/051519, US 2005/0128951, and EP 1 662 716 describe how to improve the behaviour of a bandwidth allocation system but do not define new functionalities.

The prior art also knows through the American patent US 2005/076336 (Nortel), a method and device for sequencing resources in a switched network. This American patent application more particularly describes a manner of managing resource transfers, or more generally connections between entities of a network.

### SUMMARY OF THE INVENTION

A service reservation system, within the framework of the present invention, is flexible as it enables the bandwidth to be reserved whatever the network topology, and owing to the fact that it can manage several classes of traffic. Within the framework of the present invention, a service reservation system supplies a deterministic quality of service (QoS) as it can ensure the validity and consistency of all the parameters of the QoS: guarantee of bandwidth and processing of classes of traffic. The optimisation of the reservation can carry out several bandwidth reservations between the same sources and destinations. This improves the bandwidth reservation by enabling the quantity of bandwidth reserved between two hosts to be increased or decreased, what the applications require, and by enabling different applications to reserve the bandwidth with different qualities of service. Finally, the present invention gives the mechanisms to protect the system from hosts that could corrupt the bandwidth reservations by overloading the network.

Within the context of the present invention, different classes of traffic in reserved bandwidths are managed, which is an additional functionality in relation to the systems and methods of the prior art.

With the exception of MPLS, that will perhaps supply QoS functionalities in the future in the particular case of loop-free networks, such as the Ethernet networks, there is not in the prior art, any system enabling bandwidth to be reserved and enabling processing to be provided for different classes of traffic based on a required quality of service in loop-free networks where the topology is constraint-free and unpredictable. The present invention intends to overcome the disadvantages of the prior art by proposing such a system.

For this purpose, the present invention relates, in its most generally accepted sense, to a bandwidth reservation system in a communication network comprising a centralised bandwidth manager that implements a bandwidth reservation protocol and that is linked to at least one host, characterized in that an external entity supplies the centralised bandwidth manager with an updated view of the network logical topology, and in that the centralised bandwidth manager comprises means for, on reception of a bandwidth reservation request between a source and a destination for certain class of traffic, calculating the current network path between the source and the destination by using an algorithm, said path borrowing at least one link of the network, and means for verifying on each link of the path that there is sufficient bandwidth available for the requested class of traffic in the requested reservation.

Preferably, said algorithm is a simplified version of the Dijkstra algorithm.

Advantageously, if the verification concerning the quantity of bandwidth culminates in a positive result, the bandwidth is granted and the bandwidth manager reserves bandwidth on each network link.

According to a particular implementation, the centralised manager comprises means for, during a bandwidth reservation, updating its own information and applying a network policy on each item of network equipment involved in the reservation.

Preferably, the centralised bandwidth manager comprises means for informing a host that requests bandwidth reservation whether or not it accepts a bandwidth reservation.

Advantageously, said bandwidth reservation protocol is known by the hosts of the network that wants to reserve bandwidth.

Preferably, said topology has the form of a list of network nodes and of network logical links.

According to an advantageous variant, said bandwidth reservation system comprises means for reserving bandwidth according to application requirements.

The present invention also relates to a communication device, in a communication network, implementing a bandwidth reservation protocol and linked to at least one host, characterized in that it comprises:
means for receiving, from an external entity, an updated view of the network logical topology,
means for, on reception of a bandwidth reservation request between a source and a destination for a certain class of traffic, calculating the current network path between the source and the destination by using an algorithm, said path borrowing at least one link of the network, and
means for verifying on each of the links of the path that there is sufficient bandwidth available for the requested class of traffic in the requested reservation.

As the network core equipment of a loop-free network does not supply means for a deterministic bandwidth reservation and a processing of classes of traffic, the easiest way to supply the required quality of service in a constraint free and unpredictable topology is to centralise the bandwidth reservation in a bandwidth manager since it is impossible to distribute this functionality among the network core equipment.

The American patent U.S. Pat. No. 6,941,380 (Nortel) has described a similar architecture, but that only enables bandwidth to be reserved in two specific cases of Ethernet network topology. Moreover, this system does not supply processing of classes of traffic in a reserved bandwidth, or dynamic adjustment of needs in application bandwidth.

The present invention defines a system in which it is possible to reserve bandwidth in a loop-free constraint-free and unpredictable topology and to supply traffic class discrimination within this reserved bandwidth.

The system, according to the present invention, is based on a centralised bandwidth manager that implements a protocol for the reservation of bandwidth. This protocol is known by hosts of the network that want to reserve bandwidth.

Whatever the topology of the switched network, the bandwidth manager receives bandwidth reservation requests from the hosts requesting a defined source address and a defined source application port number, a destination address and a destination application port number, a defined quantity of bandwidth and a defined class of traffic.

The bandwidth manager then processes these requests so as to determine whether the reservation can be carried out on each link of the network path between the requested source and destination. As the network topology is constraint-free, an external entity supplies the bandwidth manager with an updated view of the network logical topology. This topology is supplied as a list of network nodes and network logical links. Next, the bandwidth manager calculates the current network path between the source and the destination by using a simplified algorithm based on the Dijkstra algorithm. Once this path is calculated, the bandwidth manager uses it to verify on each link of the path that there is sufficient bandwidth available for the requested class of traffic in the reservation requested.

If the bandwidth is granted, the bandwidth manager reserves the bandwidth on each network link. This step comprises the update of its own information and the application of a network policy on each item of network equipment involved in the reservation. The bandwidth manager manages and controls the network policy.

Finally, a bandwidth manager response is sent to the requesting host telling it whether or not it accepts.

The hosts that know the bandwidth reservation process are also capable of freeing the use of the bandwidth, of requesting an increase or decrease in the reserved bandwidth. The process for requesting an increase of the reserved bandwidth is the same as for a new bandwidth request: the quantity of bandwidth in the request will be the new reserved quantity of bandwidth.

When it is requested to reduce the reserved bandwidth, a host sends a request to free or reduce the reserved bandwidth. The bandwidth manager “un-reserves” the bandwidth by updating its own information and by updating the network policy on each item of network equipment involved in the reservation.

This capacity to increase or reduce the reserved bandwidth enables the system to adapt to the change of topology. Before removing an item of network equipment involved in the bandwidth reservations, the latter must be freed.

The present invention has many advantages, among which the following are found:

The adaptation of the bandwidth reservation to the needs of each application of the hosts of the network.

The reservation of the bandwidth is based on a constraint-free and dynamic topology of a loop-free network.

The supply of different classes of traffic for different quality of service (QoS) needs.

The reservation of bandwidth and respect for the QoS constraints in a loop-free network.

The control of the access of the hosts to the reserved bandwidth.

### BRIEF DESCRIPTION OF THE DRAWINGS

The invention will be better understood from the following description of an embodiment of the invention provided as an example by referring to the annexed figures, wherein:

FIG. 1 illustrates a network environment within the context of the present invention,

FIG. 2 illustrates a bandwidth manager and a network topology discovery module,

FIG. 3 illustrates a limitation on sources, the system having the knowledge of the bandwidth reservation procedure,

FIG. 4 illustrates a limitation on sources, the system not having the knowledge of the bandwidth reservation procedure, and

FIG. 5 shows the switching policy on network core devices.

### DETAILED DESCRIPTION OF THE EMBODIMENTS OF THE INVENTION

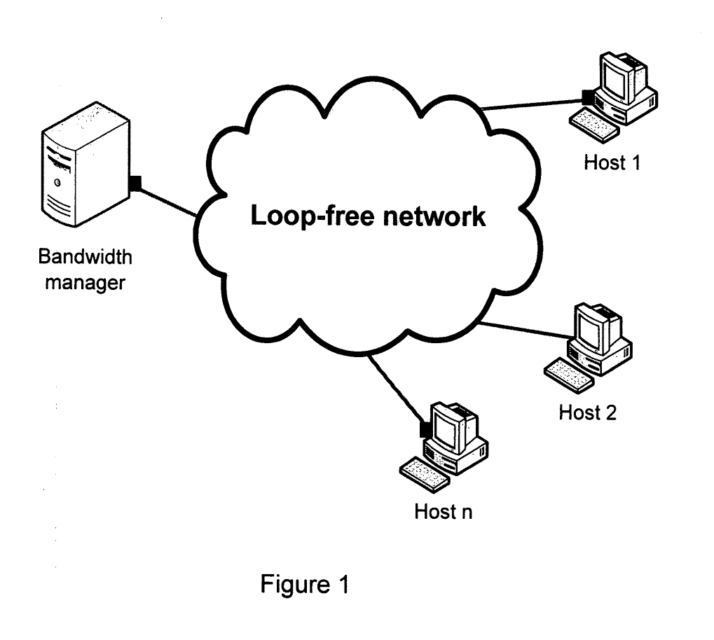

Within the context of the present invention, the bandwidth reservation system is based on a centralised manager, that receives bandwidth requests from the hosts of the network that want to reserve bandwidth. The network is loop free and has an unpredictable and constraint-free topology. There are an indefinite number of hosts and items of network equipment. The network architecture, that is the manner in which the network equipment is connected, is constraint-free. The network environment is shown in FIG. 1.

The network core equipment do not know or do not understand the bandwidth reservation procedure. They simply see standard network messages transiting across the network. Some hosts, those that want to reserve bandwidth and necessarily the network manager, know the bandwidth reservation procedure but all the hosts are not required to understand the protocol.

A centralised bandwidth manager receives bandwidth reservation requests from hosts on the network that request guarantees in terms of quality of service.

The bandwidth reservation process comprises the following steps:
1. A host sends a bandwidth reservation request comprising a quantity of bandwidth to reserve as well as a source and a destination.
2. The bandwidth manager receives this request.
3. The bandwidth manager verifies that there is sufficient bandwidth on each of the links of the network involved in the reservation. It also checks that the host requesting the reservation has the permission to reserve the bandwidth by being based on a list of hosts having this type of right. The choice and generation of this set of links is not obvious. This is why the methods and systems of the prior art limit the reservation possibilities to topologies with constraints.
4. If the reservation of bandwidth can be granted, the bandwidth manager reserves the bandwidth.
5. The bandwidth manager sends a response indicating whether or not the bandwidth reservation has been granted.

The present invention proposes the following functionality: the adaptation of the bandwidth reservation by being based on the needs of the applications. This enables the bandwidth reservation system to be optimised and made more flexible by adapting the bandwidth reservation to the needs of each type of application on each host of the network. The bandwidth adaptation assumes having a means to vary the quantity of bandwidth for a reservation. To enable each application of each host to reserve bandwidth according to its needs assumes that the information contained in the bandwidth requests are more extended.

The bandwidth reservation system can modify the quantity of bandwidth reserved for a specified bandwidth reservation. This is realized by means of different types of messages that are respectively used for:
a new bandwidth reservation (standard bandwidth request),
an increase in reserved bandwidth,
a decrease in reserved bandwidth, and
a clearance of a bandwidth reservation.

Upon reception of a message belonging to one of the categories cited above, the bandwidth manager can have two different behaviours. If more bandwidth is requested from it (new bandwidth reservation or else increase in bandwidth), the bandwidth manager applies the same process as for a standard bandwidth request as defined previously, including all the added mechanisms and the characteristics that fall within the framework of the present invention. If less bandwidth is requested from it (clearance or reduction of reserved bandwidth), the bandwidth manager processes the messages as follows:

1. A host sends a bandwidth reservation request comprising the quantity of bandwidth to conserve as well as sufficient information for the identification of the existing bandwidth reservation.
2. The bandwidth manager receives the request.
3. (The bandwidth manager does not need to verify whether the clearance of bandwidth is possible as it is always possible).
4. The bandwidth manager updates its internal tables.
5. The bandwidth manager sends a response indicating that the reservation has been modified.

The quality of service requirement of a network does not depend only on the source and the destination of a particular traffic. It is obvious that this also depends on the type of services that the network uses. For example, there is no time constraint for a file exchange across a network, whereas a “voice” communication requires guarantees in terms of time and jitter. These two types of services can be used on the same host of the network. Hence, there is a need to differentiate the type of service in bandwidth reservations.

The type of service that uses a network is defined by the application port number of the network transport layer. These port numbers are, in a common manner, defined for the different existing transport protocols. Hence, this value corresponds exactly to the type of service.

The bandwidth reservation system uses, for the identification of a bandwidth reservation, the application port numbers of the source and the destination.

The identification of a bandwidth reservation is used everywhere that there is a need to differentiate several bandwidth reservations. This includes the bandwidth reservation messages and the internal tables of the bandwidth manager.

The methods and systems of the prior art are based on a topology with constraints, that is fixed cases of network topology that must be known by the system before bandwidth reservations begin, and that must not vary over time.

The bandwidth reservation system according to the present invention can reserve bandwidth in a loop-free network with an unpredictable and constraint-free topology. This means that the system operates whatever the topology of the network, that the topology has not been given in a statistical manner to the system and that the changes of topology are managed in an automatic manner by the system.

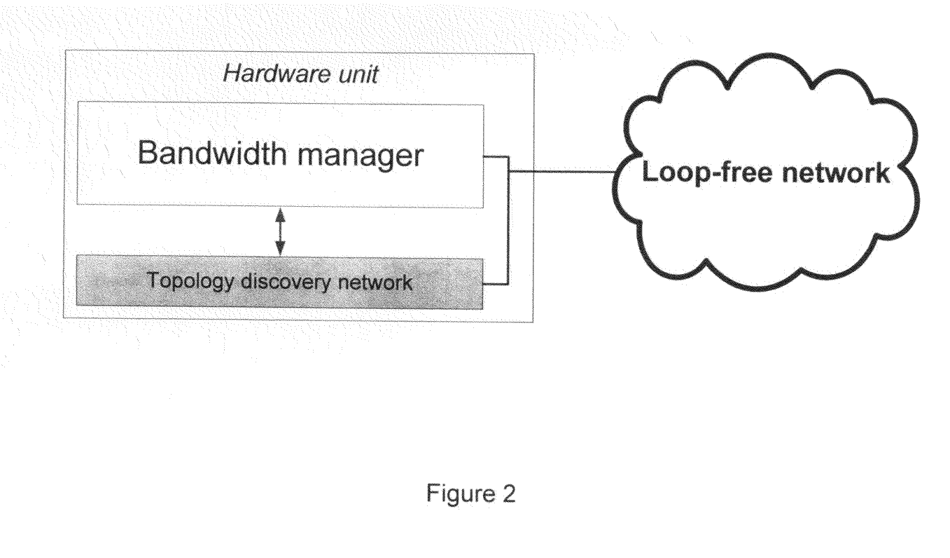

This characteristic is based on a dynamic discovery module of the topology of a network, called topology module and that gives the bandwidth reservation manager an updated view of the topology of a network. This module supplies a representation of the loop-free network topology viewed from the bandwidth manager. Hence, this module is installed on the same hardware and in the same software environment as the bandwidth manager. FIG. 2 illustrates a bandwidth manager and a network topology discovery module.

The topology module operates independently from the bandwidth manager. It always maintains an exact and updated view of the network topology. For example, the network can be of the Ethernet type.

There are two types of communications between the bandwidth manager and the topology module: the bandwidth manager requests a representation of the topology by calling a function supplied by the topology module and then, the topology module warns the bandwidth manager of a change of topology. This enables the bandwidth manager to always be informed, in an exact manner, of the current network topology.

The topology module supplies a topology representation in the form of a table of nodes of the network and of a table of the links of the loop-free network.

The table of the nodes contains the following information: a unique and invariable identifier of the equipment (this can be the physical address of the equipment if the latter does not change over time).

The table of the links contains the following information:
Type of the network: Ethernet, Wi-Fi, Wi-Max, etc.,
Pair (node identifiers, physical port numbers) at the two extremities of the link,
Total bandwidth available on the link in the case of a wire link.

The reservation is applied according to the network transmission used.

The bandwidth manager is now aware of the topology of the loop-free network. It uses this representation to adapt its reservation procedure to the constraint-free topology.

During the third step of the bandwidth reservation procedure (new bandwidth reservation or increase of reserved bandwidth, see above), the bandwidth manager verifies whether there is sufficient bandwidth available on each of the links of the network involved in the reservation. This set of links must be known in a manner to be able to determine what is the correct path within the loop-free network, that is the unique path between the source and the destination of the reservation. In the case of a topology with constraint, the path is determined in a statistical manner for each case of bandwidth reservation request. Within the context of the present invention, the topology is constraint-free. Hence, it is necessary to calculate the path within the network.

To do this, a Dijkstra algorithm can be used. The Dijkstra algorithm can calculate the different paths between two points in a graph, and calculate the shortest path between these two points, by being based on the weight of the edges of the graph. Within the context of the present invention, the graph is a node tree of the network, that is that there is a unique path between two points of the graph. As there is a unique solution for a path between the points of the tree of the network, it is unnecessary to assign weights to the edges of the network. Moreover, the algorithm is stopped once a path is found (indeed, it is the unique path).

The use of the topology module and of the Dijkstra algorithm (for example) in combination can make the bandwidth reservation system independent from the topology of the loop-free network: the topology can be constraint-free. Moreover, as the topology module warns the bandwidth manager of the changes of topology, the bandwidth manager can reserve the bandwidth in a dynamic topology. Naturally, in order to preserve the integrity of the bandwidth reservation system, before removing an item of network equipment involved in bandwidth reservations, the latter must be cleared.

The present invention also proposes another functionality: the reservation of bandwidth for different classes of traffic. The classes of traffic allow priorities to be assigned to the different network traffic while conserving the guarantee of bandwidth. These assignments of priority can ensure minimum times and jitter for a certain type of traffic while guaranteeing the reserved bandwidth for all the reserved traffic.

The bandwidth reservation process can process N classes of traffic within a reserved bandwidth. Additional information is added for the identification of the bandwidth reservation: the traffic class number. This field defines the level of priority of the reserved bandwidth in the loop-free network. The class of traffic n−1 has a lower priority than the class n which itself has a lower priority than the class n+1.

As the bandwidth guarantee is ensured in a strict manner for each class of traffic, the third step of the method for reserving more bandwidth (new bandwidth reservation or increase of the reserved bandwidth, see above) does not change irrespective of the requested class of traffic. The calculation of the set of links does not change as, naturally, the source and the destination are independent from the class of traffic. Likewise for the verification of the quantity of bandwidth available on each link of the calculated network path, the total quantity of requested bandwidth must be available whatever the class of traffic. However, the “class of traffic” of the bandwidth reservation identifier can be used in this third step in such a manner as to set up a particular processing policy of bandwidth requests. For example, it can be chosen to first process the bandwidth reservation requests of higher priority.

The second step of the reservation process is the application of the reservation in the network. The class of traffic here takes on all its importance. The bandwidth manager must apply a network policy that ensures priority assignments to the different classes of traffic.

The bandwidth reservation in a loop-free network with constraint-free topology involves setting up several procedures in order to guarantee reliable bandwidth reservations.

The bandwidth reservation is ensured by two processes:
exchange of requests/responses requesting coherent bandwidth reservations,
Application of bandwidth reservations on the network. This second step ensures that the bandwidth requests are properly respected.

The application of bandwidth reservations is set up by two functionalities. Once the coherence in terms of bandwidth has been guaranteed by the communication of bandwidth reservation, the first control to implement consists in ensuring that the sources doe not send more traffic than they are allowed in each class of traffic. The second control to implement consists in ensuring that the network will transport the streams correctly according to their guaranteed quality of service (bandwidth and class of traffic guarantee).

Several types of traffic cross a loop-free network. These different types of traffic must be recognized according to their guaranteed quality of service. A single source can send several types of traffic. The network core equipment will base their transmission processes on the type of traffic.

The network must recognize N+2 types of traffic where N is the number of classes of traffic defined above. N classes of traffic use the bandwidth reservation method.

The data traffic that does not use the bandwidth reservation method corresponds to the “Best effort” type of traffic that has no guarantee, neither for the time, nor for the jitter nor for the loss of packets.

The last type of data is the traffic dedicated to the management of the bandwidth reservation system. This comprises the exchanges carried out during the reservation method and the traffic generated by the topology module. The bandwidth of this traffic is maximized on each link of the loop-free network in such a manner as to be reserved before any other reservation of bandwidth. This type of traffic has the highest priority in order to guarantee that the bandwidth reservation system can always operate correctly.

The present invention defines a system in which there are N+2 levels of priority required in the network devices, where N is the number of classes of traffic as defined above.

The sources must indicate the type of traffic for the frames that they send. The network core devices must correctly transport the traffic and the availability in terms of bandwidth is guaranteed by the bandwidth reservation command. This equipment only has to guarantee the priority of each frame according to the indications concerning the type of traffic supplied by the sources in the frames.

It has been indicated that the hosts are able not to know the bandwidth reservation procedure. Hence, these hosts send traffic without any indication concerning the type of traffic. In these cases, the network core equipment must consider the traffic as belonging to the “best effort” type of traffic, that is having the lowest priority.

Several technologies exist for marking the traffic. In the case of the Ethernet protocol, VLAN is a solution for indicating the membership of a network frame to a group. The present invention is independent form the choice of the technology.

The hosts implementing the bandwidth management procedure must respect the orders that they have received from the bandwidth manager. The behaviour varies according to the type of traffic:
Bandwidth management traffic: a sufficient quantity of bandwidth was reserved by the bandwidth reservation system for this type of traffic. Hence, the sources send this type of traffic as agreed.
Reserved bandwidth: the sources must only transmit traffic for a particular reservation and a particular class of traffic if they have received an accepted reservation request for this bandwidth reservation. The sources must also respect the quantity of reserved bandwidth.
“Best effort” type of traffic: the sources must only transmit this type of traffic if there is bandwidth available after having transmitted the two previous types of traffic.

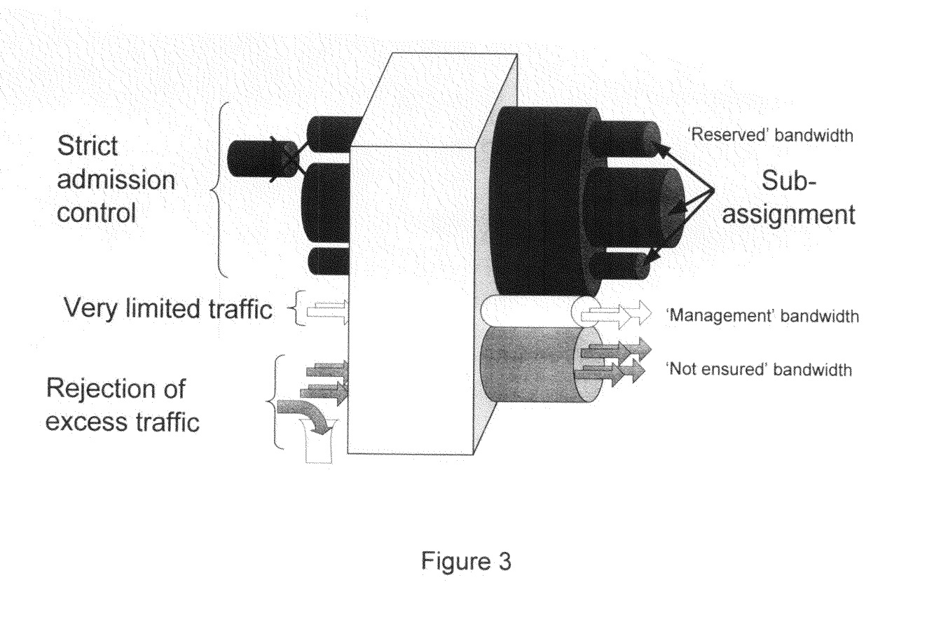

FIG. 3 illustrates the behaviour of sources implementing the bandwidth reservation procedure. FIG. 3 shows the three types of traffic cited in the paragraph above: the bandwidth management traffic, the traffic corresponding to reserved bandwidth and the “best effort” type of traffic. According to the type of traffic sent, the source has a different behaviour. In FIG. 3, each level of grey means that the type of traffic is indicated in the frame by sources.

To send the reserved stream, the source must perform a bandwidth reservation request as indicated above. If the request is accepted, the source can send the stream by marking it as “reserved” type. If the request is not accepted, then the source does not send a stream as indicated by a barred tube.

The management stream of the bandwidth is always sent as described in the previous paragraph.

The source sends as much “best effort” type of traffic as it can, that is, the rest of the bandwidth of its network interface. The additional traffic that it wants to send is either rejected (as indicated by the down arrow in FIG. 3), or sent subsequently.

The sources that do not implement the bandwidth reservation procedure transmit only unmarked traffic that will be considered as “Best effort” traffic by the network core equipment as this was indicated above.

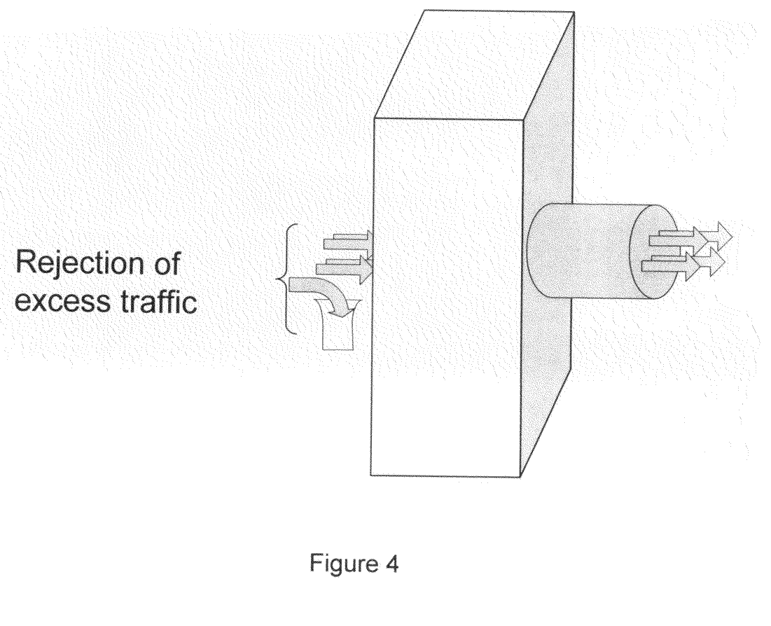

FIG. 4 illustrates the behaviour of sources that do not implement the bandwidth reservation procedure. Here, the sources do not indicate the type of traffic. This type of source behaves as a source implementing the bandwidth reservation procedure does so with “best effort” type of traffic. The excess traffic is rejected, as indicated by the down arrow in FIG. 4.

The policy management of the network is another functionality of the bandwidth reservation application. The bandwidth manager guarantees the distribution of the correction indications of bandwidth use within the entire loop-free network. Next, the sources respect these indications as is explained above. The last control to be set up in order to guarantee a correct transport of the streams consists in the application of a correct network policy on all the network core equipment within the loop-free network.

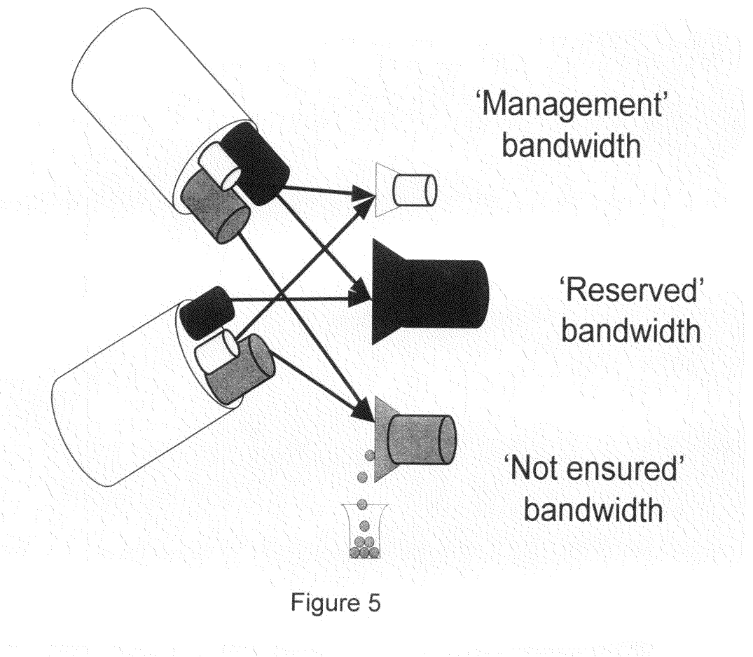

This policy must only guarantee the respect of the priorities such as is described above. FIG. 5 illustrates in what manner a network core equipment must behave when it must face different types of traffic.

The management of traffic has the highest priority and the bandwidth manager guarantees that there is sufficient bandwidth on each link. Hence, this traffic is always transmitted and transported within the network. The reserved bandwidth consists in N classes of traffic. Each of them is processed according to its defined priority. The bandwidth manager guarantees that there is sufficient bandwidth on each link. Hence, this traffic is always transmitted and transported within the network. Finally, the “Best effort” type of traffic has the lowest priority and cannot be transported if there is not enough bandwidth on a link. In this case, a part of the traffic is rejected by the network core equipment as FIG. 5 shows.

This behaviour is evaluated at the level of each network core equipment but the implementation of this behaviour can vary from one link to another and from one item of network equipment to another. The bandwidth reservation system according to the present invention is independent of the type of line used on the network and uses the “type of link” field supplied by the topology module in the table of links (see above) in order to apply the technology implementing the behaviour.

Several techniques already exist for the implementation of this behaviour. For Ethernet, the priority can be configured for each VLAN. Network links implement the opening of the connection with a specific priority.

The bandwidth reservation system accepts on the network the network hosts that know the bandwidth reservation procedure and the hosts that do not know it. In order to prevent a non-secure host from reserving bandwidth, the use of a list of hosts (“registered hosts”) that have the permission to reserve bandwidth has been previously imagined. However, the fact of preventing non-secure hosts from requesting bandwidth does not prevent these same hosts from sending traffic having a high priority, which could cause degradations in the correct bandwidth reservations.

The bandwidth management system supplies mechanisms for managing in a dynamic manner the access list of hosts that have the permission to reserve bandwidth and to send traffic having a priority, and to prevent unregistered hosts from sending reserved traffic. This access list is present in the same hardware entity as the bandwidth manager, in our example.

This functionality uses the capacity of the network core equipment to block traffic for a given physical port and a certain type of traffic. The registration of a host wanting to reserve bandwidth follows the procedure below:

1. Initialisation of the system: each port of each item of network core equipment blocks all the types of traffic with the exception of the one that has the lowest priority, that is the “Best effort” type of traffic. The access list is reset: it is emptied.

In this step, the host cannot send any bandwidth reservation requests as the management traffic is blocked. The traffic comprising priorities is also blocked.

2. A host that wants to reserve bandwidth must register itself beforehand with the bandwidth manager by sending, as “Best effort” traffic, a registration request to the bandwidth manager.

3. The manager receives the registration request and decides, by using its access policy as a basis, to allow or not to allow this host to request reserved bandwidth.

4. If the bandwidth manager allows the host to reserve bandwidth, it adds its identity to the access list and unblocks the management traffic on the port of the network core equipment to which the host is connected.

In this step, the host can request reserved bandwidth as it can send management traffic. However, it cannot send reserved traffic as the traffic with priority is still blocked on the port of the network core equipment to which the host is connected.

Once a host is registered, the bandwidth manager processes the different types of bandwidth reservation as has been described above. When a reservation request is granted, the bandwidth manager, in addition to the tasks already cited, unblocks the type of traffic requested on the port of the network core equipment to which the host is connected.

In this step, the host can send non-reserved traffic, bandwidth reservation requests and traffic for which it has requested a bandwidth reservation.

The invention is described in the preceding text as an example. It is understood that those skilled in the art are capable of producing variants of the invention without leaving the scope of the patent.

1-9. (canceled)

10. Bandwidth reservation system in a communication network comprising a centralized bandwidth manager that implements a bandwidth reservation protocol and that is linked to at least one host,
wherein an external entity supplies the centralized bandwidth manager with an updated view of the network logical topology,
and wherein the centralized bandwidth manager comprises means for, on reception of a bandwidth reservation request between a source and a destination for certain class of traffic, calculating the current network path between the source and the destination by using an algorithm, said path borrowing at least one link of the network, and means for verifying on each link of the path that there is sufficient bandwidth available for the requested class of traffic in the requested reservation.

11. Bandwidth reservation system in a communication network according to claim 10, wherein said algorithm is a simplified version of the Dijkstra algorithm.

12. Bandwidth reservation system in a communication network according to claim 10, wherein, if the verification concerning the quantity of bandwidth culminates in a positive result, the bandwidth is granted and the bandwidth manager reserves bandwidth on each network link.

13. Bandwidth reservation system in a communication network according to claim 12, wherein the centralized manager comprises means for, during a bandwidth reservation, updating its own information and applying a network policy on each item of network equipment involved in the reservation.

14. Bandwidth reservation system in a communication network according to claim 10, wherein the centralized bandwidth manager comprises means for informing a host that requests bandwidth reservation whether or not it accepts a bandwidth reservation.

15. Bandwidth reservation system in a communication network according to claim 10, wherein said bandwidth reservation protocol is known by the hosts of the network that wants to reserve bandwidth.

16. Bandwidth reservation system in a communication network according to claim 10, wherein said topology has the form of a list of network nodes and of network logical links.

17. Bandwidth reservation system in a communication network according to claim 10, wherein it comprises means for reserving bandwidth according to application requirements.

18. Communication device, in a communication network, implementing a bandwidth reservation protocol and linked to at least one host, comprising:
a. means for receiving, from an external entity, an updated view of the network logical topology,
b. means for, on reception of a bandwidth reservation request between a source and a destination for a certain class of traffic, calculating the current network path between the source and the destination by using an algorithm, said path borrowing at least one link of the network, and
c. means for verifying on each of the links of the path that there is sufficient bandwidth available for the requested class of traffic in the requested reservation.
